(19) United States
(12) Patent Application Publication
(10) Pub. No.: US 2024/0340988 A1
(43) Pub. Date: Oct. 10, 2024

(54) Methods and Apparatuses for Handling of Inter-cell Multi-TRP Configurations During Re-establishment

(71) Applicant: TELEFONAKTIEBOLAGET LM ERICSSON (PUBL), Stockholm (SE)

(72) Inventors: Icaro Leonardo DA SILVA, Solna (SE); Pradeepa RAMACHANDRA, Linkoping (SE)

(21) Appl. No.: 18/700,051

(22) PCT Filed: Oct. 14, 2022
(86) PCT No.: PCT/IB2022/059876

§ 371 Date: Apr. 10, 2024

Related U.S. Application Data
(60) Provisional application No. 63/255,674, filed on Oct. 14, 2021.

(51) Int. Cl. H04W 76/19

(52) U.S. Cl. CPC H04W 76/19

(57) ABSTRACT

There is provided a method performed by a user equipment (UE). The method comprises: receiving one or more inter-cell multiple Transmission Reception Point (mTRP) configurations; initiating a re-establishment procedure with a network node; and in response to initiating the re-establishment procedure, releasing at least one of the one or more inter-cell mTRP configurations. There is another method performed by a UE. The method comprises: receiving one or more inter-cell mTRP configurations; obtaining an indication for performing at least one of: releasing at least one of the one or more inter-cell mTRP configurations and storing at least one of the one or more inter-cell mTRP configurations, for a re-establishment procedure; initiating a re-establishment procedure with a network node; and performing one of: releasing at least one of the one or more inter-cell mTRP configurations and storing at least one of the one or more inter-cell mTRP configurations, according to the obtained indication.

### RELATED APPLICATIONS

This application claims the benefits of priority of U.S. Provisional Patent Application No. 63/255,674, entitled “Handling of inter-cell multi-TRP configurations during re-establishment” and filed at the United States Patent and Trademark Office on Oct. 14, 2021, the content of which is incorporated herein by reference.

### BACKGROUND

### Radio Resource Control (RRC) Re-Establishment Procedure

The Re-establishment procedure is an RRC procedure defined for New Radio (NR) in § 5.3.7 of Third Generation Partnership Project (3GPP) Technical Specification (TS) 38.331 (and summarized in § 9.2.3.3 of 3GPP TS 38.300). A User Equipment (UE) in RRC_CONNECTED may initiate the re-establishment procedure to continue the RRC connection, when a failure condition occurs, e.g. radio link failure (RLF), reconfiguration failure, integrity check failure. The steps involved in the re-establishment procedure are illustrated in FIG. 1, as follows:

Step 1: The UE re-establishes the connection, providing the UE Identity (Physical Cell Identity (PCI)+Cell-Radio Network Temporary Identity (C-RNTI)) to the gNodeB (gNB) where the trigger for the re-establishment occurred. In the case the re-establishment is triggered due to a RLF, the PCI is the identity of the cell the UE selects, after the RLF has been declared and while timer T311 is running.

Step 2: If the UE Context is not locally available, the gNB, requests the last serving gNB to provide UE Context data. That context fetching procedure has been introduced later in Long Term Evolution (LTE) and from the first release of NR.

Step 3: The last serving gNB provides the UE context data (if upon request. i.e., if not yet available at the gNB).

Step 4/4a: The gNB continues the re-establishment of the RRC connection. The message is sent on signalling radio bearer (SRB1). Once the re-establishment is complete/finished, the UE sends a response to the gNB (e.g. RRCReestablishmentComplete message).

Step 5/5a: The gNB may perform the reconfiguration to re-establish SRB2 and data radio bearers (DRBs) when the re-establishment procedure is ongoing. The UE may acknowledge the configuration by sending a response to the gNB (e.g. RRCReconfigurationComplete message).

Steps 6/7: If the loss of user data buffered in the last serving gNB shall be prevented, the gNB provides forwarding addresses, and the last serving gNB provides the Sequence Number (SN) status to the gNB.

Steps 8/9: The gNB performs path switch.

Step 10: The gNB triggers the release of the UE resources at the last serving gNB.

Further details of the UE actions during the re-establishment procedure are found in RRC. Some aspects of interest for the disclosure are i) the handling of stored configurations according to the Master Cell Group (MCG), e.g. lower layers, ii) cell selection while timer T311 is running, when a failure is detected and re-establishment is initiated, and iii) the steps after cell selection, such as random access to the target cell the UE performs re-establishment with.

Inter-Cell Multi-Transmit-Receive Point (mTRP) in Release (Rel)-17

RAN2 is currently discussing possible RRC models for configuring inter-cell mTRP for Rel-17, which might be also called inter-cell beam management operation. The options for the RRC models can be summarized as follows:

### 3GPP Option 1: Cell

In this option/approach, TRP with different PCI is defined as an independent cell. The following aspects are summarized based on [R2-2107948], [R2-2108478], [R2-2108632]:
This new cell is always “associated” with a legacy serving cell via the inter-cell mTRP operation. In Rel-17, the two cells share the same frequency.
The secondary TRP cell (Assisting Cell) can have same or different C-RNTI than the associated primary cell (Main cell).
The configuration of the secondary TRP cells (Assisting Cell) for addition, modification, and release is done by RRC signaling.
Every legacy serving cell (SpCell or SCell) can have an associated secondary TRP cell.
When Assisting Cell is used for Uplink (UL), Radio Link Management (RLM) should follow Assisting Cell signals (FFS whether this is part of Main cell (legacy serving cell) or as separate Assisting Cell RLM).

There could be different sub-options derived from Option 1, such as the following:
Each inter-cell mTRP configuration has its own ServingCellConfig (so the UE is configured with multiple ServingCellConfig(s), one per TRP) and its own ServingCellConfigCommon (so the UE is configured with multiple ServingCellConfig(s), one per TRP);
Each inter-cell TRP configuration has its own ServingCellConfig (so the UE is configured with multiple ServingCellConfig(s), one per TRP), but there is a single ServingCellConfigCommon, possibly associated to the initial PCell (the PCell the UE initially connects to and/or performs reconfiguration with sync).

### 3GPP Option 2: Bandwidth Part (BWP)

In this option/approach, TRP with different PCI is modelled as additional Bandwidth Part (BWP). The following aspects are summarized based on [R2-2107585] and [R2-2108632]:
Configure the different TRP as the different BWP, and the TRP activation/deactivation can be achieved via the BWP switching mechanism.
The common configuration would be kept for the source cell, i.e. the UE keeps monitoring the source cell's common channel.
For the TRP with different PCI, it has the full set of the PUCCH/PDCCH/PDSCH/PUSCH (PxxCH) configuration, and the full set of common and dedicated configuration. Switching to TRP with different PCI is based on Layer 1 (L1) signaling.
   3GPP Option 3: Beam Resource (e.g. TCI State, QCL-Info)

In this option/approach, TRP with different PCI is modelled as a dedicated resource to enable separate beam, i.e. separate Transmission Configuration Indicator (TCI)-state/Co-Located (QCL)-information. The following is summarized based on [R2-2107906], [R2-2108632], [R2-2108656], [R2-2108807]:
The additional Synchronization Signal Block (SSB) set(s) from a non-serving cell (TRP with different PCI) is configured within the serving cell configuration and associated with an index. This index can then be used for associating TCI states, Channel State Information (CSI) measurement configurations, potential UL configurations, etc., with the additional SSB set (PCI).
TCI state is also configured in the serving cell configuration but assigned with SSB index associated to the different PCI.
In inter-cell mTRP operation, CORESETPoolIndex with value 0 is associated with the serving cell, while CORESETPoolIndex with value 1 is associated with the non-serving cell.
All other configuration in BWP could be shared by a neighbor cell except for Physical (PHY) dedicated channels (PxxCH).
Cell-specific parameters for neighbor TRPs/Cells are shared with the source cell or cell-specific parameters are not needed on the neighbor TRPs/Cells, e.g. Random Access Channel (RACH) is not needed on the neighbor cell and RACH is triggered by PDCCH-command if needed. It is assumed that Timing Advance (TA) is always aligned between source and neighbor cells.
SSB related information of the non-serving PCI is included in the CSI configuration to configure CSI for TRP with different PCI.

One sub-option derived from Option 3 is the following:
The inter-cell mTRP configurations are within a single ServingCellConfig and there is a single ServingCellConfigCommon, even though there may be PCI-specific configurations.

### 3GPP Option 4: New Structure

In [R2-2107415], a new Option is proposed, in which a new Information Element (IE), e.g. NonServingCellConfig, is defined to include all non-serving cell information (i.e. TRP with different PCI).
Non-serving cell SSB information (at least SSB time domain position, SSB transmission periodicity, SSB transmission power) is needed in inter-cell MTRP operation.
PCI of non-serving cell is included in the new IE (e.g. NonServingCellConfig) for non-serving cell.
An index of non-serving cell with corresponding configurations is introduced to associate with TCI state.

These options describe how the “configurations needed to use radio resources for data transmission reception including resources for different PCIs” is organized within the UEs dedicated RRC configuration.

In Options 1 and 2, all physical layer configuration parameters may be set differently among the TRPs while in Option 3, most parameters are shared. Option 4 is Abstract Syntax Notation One (ASN1) coding specific hybrid which may coincide with Option 1 or Option 3.

Inter-Cell Multi-TRP (mTRP) in Rel-18 and Possibly 6G

In the last Radio Access Network (RAN) plenary meeting, the scope of Rel-18, currently called 5G Advanced is being discussion. Inter-cell beam management is one of the main topics in the area of mobility enhancements. Although it is not clear what exact solution would be adopted in Rel-18 in comparison to Rel-17 inter-cell mTRP, one possible difference is that while in Rel-17 the UE relies on control channels from a single serving cell, while it possibly receives/transmits data from/to other cells (dedicated channels having Transmission Configuration Indicator (TCI) state whose quasi-colocated (QCL) source is associated with a reference signal (RS) with PCI of that other cell), in Rel-18 it might also be possible to use common channels from these other cells. For example, Rel-17 may end up modeling inter-cell mTRP as in Option 3, while Rel-18 will model the inter-cell mTRP as in Option 1. However, these differences may not be fundamental for the present disclosure, i.e., the present disclosure is likely applicable in Rel-17 scenario, but also in a possible Rel-18 scenario for inter-cell mTRP.

In 5G times, some topics from the 4G evolution made in the first 5G release (Rel-15). It may also happen that 5G evolution topics, e.g., from 5G advanced, become part of the 6G standard. Inter-cell beam management/inter-cell mTRP are topics that may gain some attention in 6G times. If one solution is adopted in 5G evolution, another solution may be adopted in 6G.

Another topic being discussed in Rel-18 is L1/Layer 2 (L2) centric inter-cell mobility. One similarity between inter-cell mTRP and L1/L2 centric inter-cell mobility is that the UE is configured with multiple cells/PCI in the same serving frequency. In inter-cell mTRP, the UE can monitor channels on more than one cell (i.e. more than one TCI state activated, with at least one QCL source having a RS of a first cell in the primary cell's (PCell's) serving frequency, and with at least one QCL source having a RS of a second cell in the PCell's serving frequency.

### SUMMARY

There currently exist certain challenge(s). Upon the Re-establishment procedure, the UE deletes the dedicated configurations (UE-specific), within spCellConfig, if configured. The spCellConfig is the SpCell configuration for the MCG, containing the UE-specific configuration for the operation in the PCell. That spCellConfig is part of the MCG configuration (in CellGroupConfig for the MCG) and includes most of the physical layer configurations, e.g. in the IE ServingCellConfig (part of spCellConfigDedicated). As defined in RRC (TS 38.331), the IE ServingCellConfig is used to configure (add or modify) the UE with a serving cell. The parameters herein are mostly UE specific but partly also cell specific (e.g. in additionally configured bandwidth parts). For an example, see below:

| | |
|---|---|
| CellGroupConfig :: = | SEQUENCE { |

[...]

| | | | |
|---|---|---|---|
| spCellConfig | SpCellConfig | OPTIONAL, | -- Need M |

[...]
}
-- Serving cell specific MAC and PRY parametere for a SpCell:

| SpCellConfig :: = | SEQUENCE { | | |
|---|---|---|---|
| servCellIndex | ServCellIndex | OPTIONAL, | -- Cond SCG |
| reconfigurationWithSync | ReconfigurationWithSync | OPTIONAL, | -- Cond [symbol] WithSync |

| | | |
|---|---|---|
| rlf-TimersAndConstants | SetupRelease {RLF-TimersAndConstants} OPTIONAL, | [symbol] Need [symbol] |

| | | | |
|---|---|---|---|
| rlmInSyncOutOfSyncThreshold | ENUMERATED {n1} | OPTIONAL, | [symbol] eed 3 |
| spCellConfigDedicated | ServingCellConfig | OPTIONAL, | [symbol] Need [symbol] |

. . .
} [symbol]
indicates data missing or illegible when filed

In addition, the UE also releases the MCG SCell(s) and Multi-Radio Dual-Connectivity (MR-DC), e.g. Secondary Cell Group (SCG) configuration(s), if configured. These would be the configurations deleted for SCell(s).

A problem that exists is that with the introduction of inter-cell mTRP in Rel-17 and possible extensions in Rel-18 (e.g. L1/L2-centric inter-cell mobility), the UE may be configured with multiple cells/PCIs having their own per PCI/per cell configuration, not within the spCellConfig. Actually, the various 3GPP options being proposed to configure the UE with per PCI/cell configurations for inter-cell mTRP operation contain configurations which are not in spCellConfig, such as Options 1 and 4.

These cells/PCIs would also not be part of MR-DC configurations, and these multiple cells for inter-cell mTRP would not be SCell(s). Hence, upon re-establishment, the UE may remain configured with these L1 neighbor cells (for inter-cell mTRP and/or L1/L2 centric inter-cell mobility) despite the possibility that the target cell the UE is re-establishing may not support inter-cell mTRP operation and/or it does not want to configure the UE accordingly. Consequently, the UE would possibly continue to operate according to the stored inter-cell mTRP configurations and perform unnecessary measurements. An explicit release from the network to the UE, for explicitly releasing inter-cell mTRP configurations by the reception of an RRC Reconfiguration before re-establishment occurs is also not possible, as the re-establishment is triggered upon some failure in the operation of the UE with the source cell (where the UE was operating according to the inter-cell mTRP configurations).

At the same time, releasing inter-cell mTRP in all cases/scenarios is not optimal. For example, it may be possible that during a handover (HO) of a UE configured with inter-cell mTRP in the source cell, upon HO failure, the UE initiates re-establishment to a cell which is prepared with the UE AS context and, which is capable of operating according to inter-cell mTRP. If that cell is within the same Distributed Unit (DU), for example, it is likely that it would configure the UE with at least some of the same cells used for inter-cell mTRP in the source cell, hence, deleting these configurations would have been a waste of signalling, as some of the same cells would be added again upon re-establishment.

At the network side, there is also the risk of ambiguities if this solution is adopted, i.e., it is not clear to the network which UEs would release inter-cell mTRP configurations and which UEs would keep the stored inter-cell mTRP configurations.

Certain aspects of the disclosure and their embodiments may provide solutions to these or other challenges.

Generally speaking, the embodiments allow the UE to either release or keep the stored inter-cell mTRP configuration(s), when the UE initiates a re-establishment procedure to avoid ambiguities with the network, which should also delete or keep the stored configurations, when the UE AS context is fetched and the network needs to re-establish the UE's connection.

In one aspect, there is provided a method in a UE, for re-establishing a connection with a first network node, in the context of inter-cell mTRP. The method comprises: receiving one or more inter-cell mTRP configurations; initiating a re-establishment procedure with a network node; and in response to initiating the re-establishment procedure, releasing at least one of the one or more inter-cell mTRP configurations. There is provided another method in a UE. The method comprises: receiving one or more inter-cell mTRP configurations; obtaining an indication for performing at least one of: releasing at least one of the one or more inter-cell mTRP configurations and storing at least one of the one or more inter-cell mTRP configurations, for a re-establishment procedure; initiating a re-establishment procedure with a network node; and performing one of: releasing at least one of the one or more inter-cell mTRP configurations and storing at least one of the one or more inter-cell mTRP configurations, according to the obtained indication. A UE for implementing these methods is also provided.

In another aspect, there is provided a method in a network node for re-establishing a connection for a UE. The method comprises: receiving a re-establishment request from a UE which is configured with one or more inter-cell mTRP configurations; obtaining an indication to perform one of: releasing at least one of the one or more inter-cell mTRP configurations and storing at least one of the one or more inter-cell mTRP configurations; and performing one of: releasing and storing at least one of the one or more inter-cell mTRP configurations according to the indication. A network node for implementing the method is also provided.

Certain embodiments may provide the following technical advantage(s).

With the embodiments of this disclosure, the ambiguity in UE behavior concerning inter-cell mTRP operations, when the UE initiates a re-establishment procedure and tries to re-establish in a target cell (of a gNB) can be eliminated.

For example, when the UE deletes the inter-cell mTRP configurations and the network also does that, the network can add new inter-cell mTRP configurations in the first RRC Reconfiguration after the re-establishment without leading to re-configuration failures. These failures, which are prevented by the present disclosure, could have occurred if the network tries to add a new inter-cell mTRP configuration using a configuration identity (ID) for a configuration the UE has not deleted. Or, even if the network does not add any inter-cell mTRP configurations and the UE keeps its previous inter-cell mTRP configurations, but the network is not aware of that (because it was deleted) the UE may search for RSs for performing measurements and not find them (because the network is not transmitting them) and/or report measurements in resources the network does not assume to be configured any longer for that UE, thus creating interference in the system. Hence, interference prevention is another advantage of the disclosure.

The embodiments also prevent other problems, such as the network transmitting Media Access Control (MAC) Control Elements (CEs) for L1/L2 centric inter-cell mobility and/or for inter-cell mTRP transmissions/receptions for a UE which is not configured with inter-cell mTRP and/or inter-cell mobility, which may lead to failure declarations at the UE.

As the disclosure enables the solutions associated to the storage of the inter-cell mTRP configurations by the UE between state transitions, the overhead of over-the-air transmission of inter-cell mTRP configurations by the cell in which the UE re-establishes is reduced.

### BRIEF DESCRIPTION OF THE DRAWINGS

Exemplary embodiments will be described in more detail with reference to the following figures, in which:

FIG. 1 illustrates a signal diagram for the re-establishment procedure.

FIG. 2 illustrates an exemplary signal flow chart for the case when the UE releases at least one inter-cell mTRP configuration and re-establishes in the last serving gNB, according to an embodiment.

FIG. 3 illustrates an exemplary signal flow chart for the case when the UE keeps/stores at least one inter-cell mTRP configuration and re-establishes in the last serving gNB, according to an embodiment.

FIG. 4 illustrates an exemplary signal flow chart for the case when the UE releases at least one inter-cell mTRP configuration and re-establishes in a cell from a gNB which received the UE context during a HO preparation, according to an embodiment.

FIG. 5 illustrates an exemplary signal flow chart for the case when the UE releases at least one inter-cell mTRP configuration and re-establishes in a cell from a gNB which is not prepared and which is the gNB that releases the inter-cell mTRP configuration(s) from the UE context, according to an embodiment.

FIG. 6 illustrates an exemplary signal flow chart for the case when the UE releases at least one inter-cell mTRP configuration and re-establishes in a cell from a gNB which is not prepared and the last serving gNB releases the inter-cell mTRP configuration(s) from the UE context before providing it to the new gNB, according to an embodiment.

FIG. 7 illustrates an exemplary signal flow chart for the case when the UE keeps/stores at least one inter-cell mTRP configuration and re-establishes in a cell from a gNB which is not prepared, according to an embodiment.

FIGS. 8 and 9 illustrates a flow chart of a method in a UE, according to an embodiment.

FIGS. 10 and 11 show a flow chart of a method in a network node, according to an embodiment.

FIG. 12 shows an example of a communication system, according to an embodiment.

FIG. 13 shows a schematic diagram of a UE, according to an embodiment.

FIG. 14 shows a schematic diagram of a network node, according to an embodiment.

FIG. 15 illustrates a block diagram of a host.

FIG. 16 illustrates a block diagram illustrating a virtualization environment.

FIG. 17 shows a communication diagram of a host.

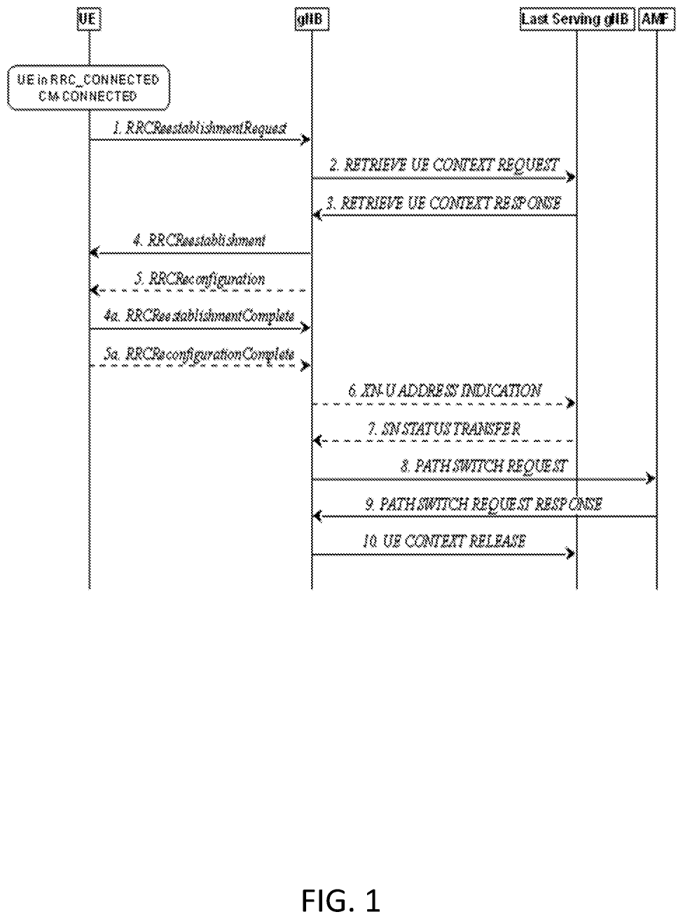

### DETAILED DESCRIPTION

Some of the embodiments contemplated herein will now be described more fully with reference to the accompanying drawings. Embodiments are provided by way of example to convey the scope of the subject matter to those skilled in the art.

### Disclaimers/Definitions

The term “PCI” corresponds to a cell identifier, such as the one encoded by one or more synchronization sequences, e.g. the Primary Synchronization Sequence (PSS) and the Secondary Synchronization Sequence (SSS). One example of the PCI is defined in the NR specifications, such as in TS 38.311.

The terms “TCI state” and “TCI state Identity (ID)” are used to refer to the TCI state configuration and a TCI state identity/identifier as defined in the NR specifications, e.g. TS 38.331 and/or TS 38.213. However, this disclosure is also applicable to any indication of a downlink (DL) Beam (beam indication) that indicates to the UE that it needs to monitor a given RS, transmitted in a spatial direction, which can be called a “beam”. In the case of a TCI state, it has an associated QCL configuration, which may comprise a RS configuration.

The term “beam” used in the text can correspond to a RS that is transmitted in a given spatial direction. Or the other way around: when a RS is described, that may be a RS that is beamformed, i.e. it may correspond to a beam. For example, a beam or an RS may refer to an SS/Physical Broadcast Channel (PBCH) Block (SSB) or layer 3 configured Channel State Information (CSI)-RS. During a half-frame, different SSBs may be transmitted in different spatial directions (i.e. using different beams, spanning the coverage area of a cell). That corresponds to different SSBs meaning different beams.

The term “UE context” (or UE AS context) comprises inter-cell mTRP configuration(s). It corresponds to any of the following or combinations of the following: i) the UE's RRC configuration for the different layers of the protocol stack, such as any parameter or sets of parameters that may be included in an RRCReconfiguration, RRCResume, RRCSetup message as defined in TS 38.311 and/or; ii) parameters the UE is configured with for operation with the RAN, for configuring layers in the protocol stack such as the Physical (PHY) Layer, the MAC layer, the Radio Link Control (RLC) layer, the Packet Data Convergence Protocol (PDCP) layer, the Service Data Adaptation Protocol (SDAP) layer; iii) state variables (e.g. timer values, counter values) for the UE's operation in the RAN, for configuring layers in the protocol stack, such as the PHY, MAC, RLC 1, PDCP and SDAP layer; iv) UE's security context, including at least security keys (e.g. KgNB, S-KgNB, integrity protocol key(s), ciphering key(s)), security counter(s), e.g. Next hop Chaining counter (NCC), S-K Counter, security capabilities; v) UE's capabilities, e.g. from the RAN's perspective, called radio capabilities.

One similarity between inter-cell mTRP and L1/L2 centric inter-cell mobility is that the UE is configured with multiple cells/PCI in the same serving frequency. In inter-cell mTRP, the UE can monitor channels on more than one cell (i.e. more than one TCI state activated, with at least one QCL source having a RS of a first cell in the PCell's serving frequency, and with at least one QCL source having a RS of a second cell in the PCell's serving frequency.

The disclosed methods are implemented in a UE configured with inter-cell mTRP, where the inter-cell mTRP configuration(s) may be provided as any of the Options discussed for inter-cell mTRP/inter-cell beam management in Rel-17 and may also be applicable for Rel-18.

Generally speaking, the methods herein disclosed allow the UE to either release or keep the stored inter-cell mTRP configuration(s), when the UE initiates a re-establishment procedure, in order to avoid ambiguities with the network node. To do so, the network node should act accordingly, e.g. either delete/release or keep the stored inter-cell mTRP configurations, when the UE AS context is fetched and the network node needs to re-establish the UE's connection. In one example, the UE and the network node can be configured (or decide) to always release or always keep the inter-cell mTRP configurations. In another example, the network node may determine to keep one or more inter-cell mTRP configurations. The network node indicates this to the UE so that both the UE and the network node keep the one or more inter-cell mTRP configurations. The UE can receive a message comprising such indication from the network node. In another example, the network node may determine to release one or more inter-cell mTRP configurations. The network node indicates this to the UE so that both the UE and the network node release the one or more inter-cell mTRP configurations. The UE can receive a message comprising such indication from the network node. The indication of releasing or keeping one or more inter-cell mTRP configurations can be stored in the UE context associated with the UE, when the UE receives the message including such an indication, from the network node.

Some more detailed examples are provided below with reference to figures.

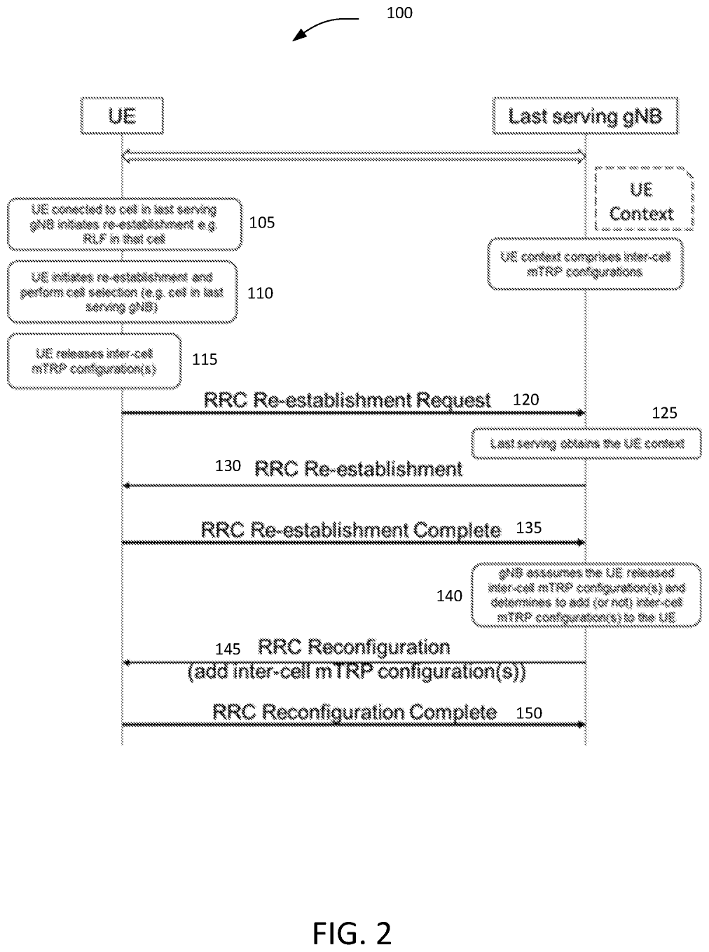

For example, FIG. 2 illustrates a signaling flowchart 100 of a UE, which releases at least one inter-cell mTRP configuration and re-establishes in the last serving gNB.

In this example, the UE is configured to release one or more inter-cell mTRP configurations upon initiating the re-establishment procedure. For instance, the UE can release the inter-cell mTRP configurations for all cell candidates for inter-cell mTRP. The network node (e.g. last serving gNB) may have determined to release one or more inter-cell mTRP configurations and indicated such action to the UE. Alternatively, both the network node and the UE have decided to release one or more inter-cell mTRP configurations.

As shown in FIG. 2, first the UE and the network node (e.g. last serving gNB) are connected to each other. The network node has the UE context stored in its memory. The UE context comprises the inter-cell mTRP configurations for example.

Upon/after the UE declares/detects a RLF, the UE initiates the re-establishment procedure (step 105). The UE also performs a cell selection (e.g. selects a cell in the last serving gNB) in step 110. The UE releases one or more of the inter-cell mTRP configurations in step 115. There may be different timings for the release, e.g. the UE releases the inter-cell mTRP configurations upon declaring RLF, or as part of the re-establishment initialization procedure.

The UE sends a RRC re-establishment request message to the network node (step 120).

The network node is aware that the UE has deleted (released, discarded) one or more of its inter-cell mTRP configurations. Therefore, upon receiving the RRC Reestablishment Request message (e.g. RRCReestablishmentRequest) and after obtaining the UE context from the last serving node in step 125 (e.g. retrieving it from the memory, in case the UE tries to re-establish to a cell of the last serving gNB), the target node (e.g. last serving gNB), with which the UE is trying to re-establish, deletes (releases, discards) the one or more inter-cell mTRP configurations from the UE context, before possibly deciding to add new inter-cell mTRP configurations. Further, it should be noted that the source node (e.g. last serving gNB) that served the UE before the RLF could remove the one or more inter-cell mTRP configurations from the UE context upon receiving a UE context fetch request from the re-establishment node (e.g. target node). In this case, the UE context received by the re-establishment node is already without the one or more inter-cell mTRP configurations.

In step 130, the network node responds to the re-establishment request by sending a RRC Re-establishment message to the UE.

The UE sends a Re-establishment Complete message to the network node (step 135).

In step 140, the network node can determine to add or not one or more inter-cell mTRP configurations to the UE.

In step 145, the network node sends a RRC reconfiguration message to the UE, the RRC reconfiguration message comprises the added one or more inter-cell mTRP configurations (if it was determined so in step 140).

The UE sends a reconfiguration complete message to the network node (step 150).

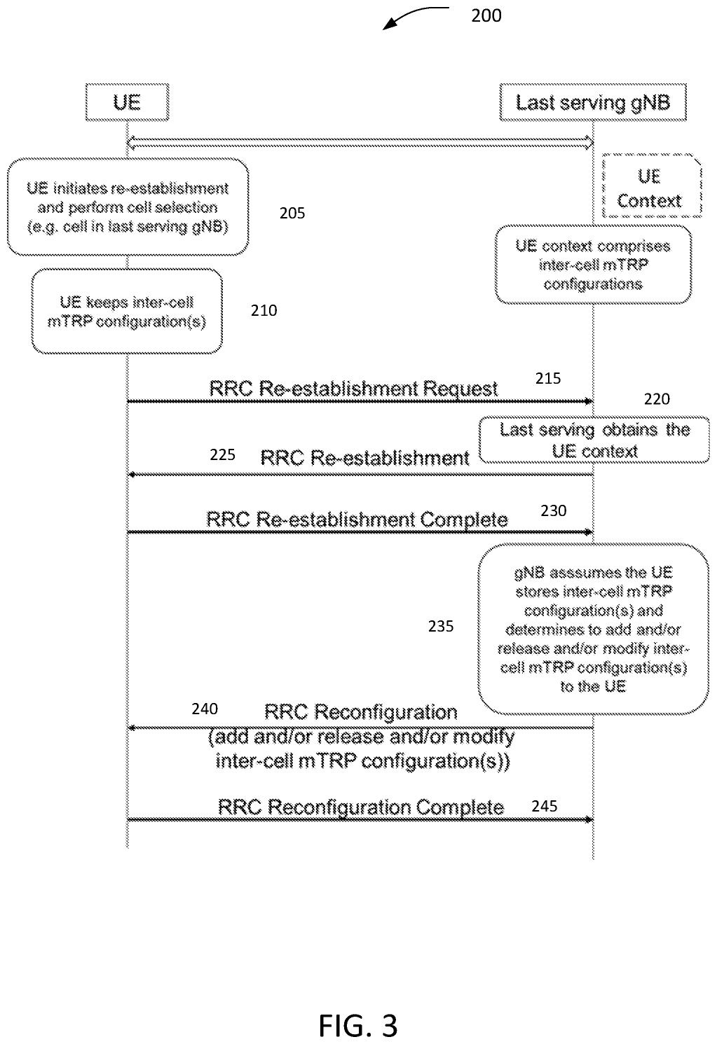

FIG. 3 illustrates an example signaling flowchart 200 of a UE, which keeps (or stores) at least one inter-cell mTRP configuration and re-establishes in the last serving gNB.

In this case, the UE is configured to keep (store) at least one of the inter-cell mTRP configurations upon initiating the re-establishment procedure. The network node (e.g. last serving gNB) may have determined to keep one or more inter-cell mTRP configurations and indicated such action to the UE. Alternatively, both the network node and the UE have decided to keep one or more inter-cell mTRP configurations.

As shown in FIG. 3, first the UE and the network node (e.g. last serving gNB) are connected to each other. The network node has the UE context stored in its memory. The UE context comprises the inter-cell mTRP configurations. In step 205, the UE performs the re-establishment procedure towards a cell being served by the same network node (e.g. last serving gNB) as the cell to which the UE was connected before initiating the re-establishment procedure. The UE also performs a cell selection (e.g. selects a cell in the last serving gNB).

In step 210, the UE keeps one or more inter-cell mTRP configurations.

In step 215, the UE sends a Re-establishment Request message to the network node.

As the re-establishment node and the previous serving node are the same, there is no explicit X2/Xn signaling associated to fetching the UE context. There may be UE context movement via the memory management in that node, e.g. the UE context is obtained from the memory (step 220).

In step 225, the network node responds to the re-establishment request by sending a RRC Re-establishment message to the UE.

In step 230, the UE sends a Re-establishment Complete message to the network node.

In step 235, the network node can determine to add one or more inter-cell mTRP configurations and/or release one or more inter-cell mTRP configurations and/or modify the inter-cell m TRP configurations for the UE. As the re-establishment node (e.g. network node/target node) is aware that the UE has kept (stored) one or more of the inter-cell mTRP configurations, it can send the delta signaling associated to the new inter-cell mTRP configurations, i.e., it can add/remove/modify the inter-cell mTRP configurations stored at the UE with an RRC Reconfiguration message (step 240). In one option, parameters for inter-cell mTRP can be defined as needed with code M (as defined in TS 38.331), meaning that upon receiving a message with the parameter absent and having the parameter stored, the UE assumes the stored parameter as valid and operates accordingly.

In step 245, the UE sends a Reconfiguration Complete message to the network node.

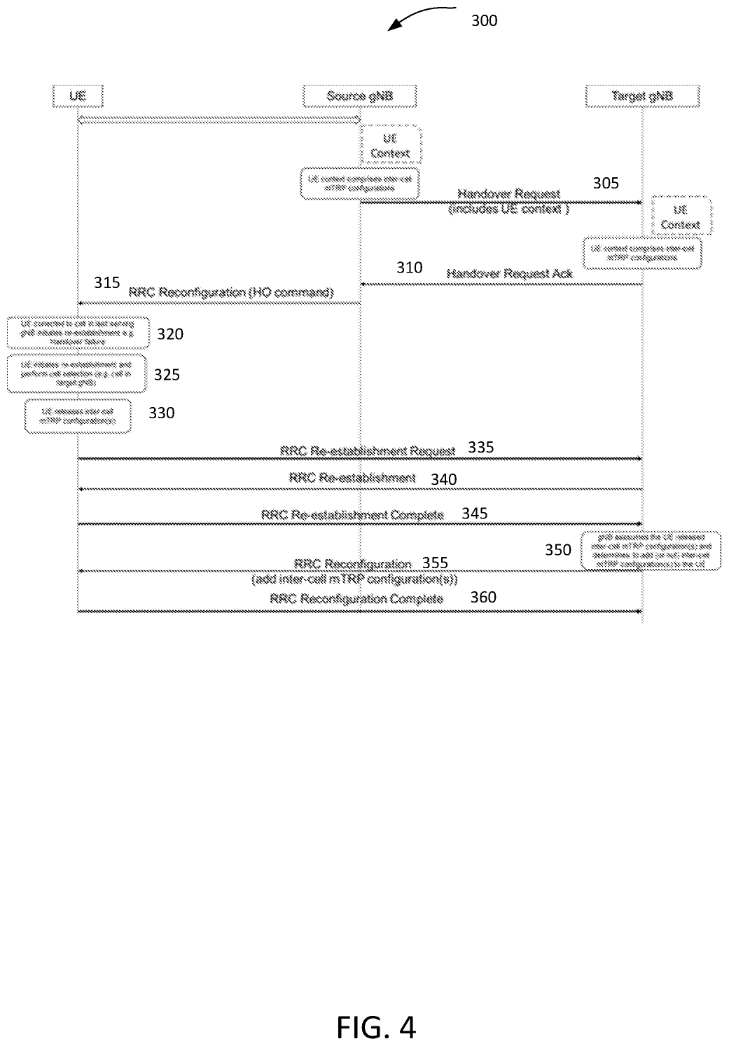

The example signaling flowchart 300 of FIG. 4 illustrates the case when the UE releases at least one inter-cell mTRP configuration and re-establishes in a cell from a gNB which received the UE context during the HO preparation.

For example, the UE is configured to release at least one of the inter-cell mTRP configurations upon initiating the re-establishment procedure. The network nodes (e.g. source gNB and/or target gNB) may have determined to release one or more inter-cell mTRP configurations and indicated such action to the UE. Alternatively, both the network nodes and the UE have decided to release one or more inter-cell mTRP configurations.

The re-establishment cell (i.e. the cell the UE is trying to re-establish, selected while timer T311 was running) is served by (is of) a network node (e.g. the target gNB), which is the same as the network node associated with the target cell of the HO.

As shown in FIG. 4, first the UE is connected to the source gNB, in which the UE context is stored. The UE context comprises the inter-cell mTRP configurations. In step 305, the source gNB sends a HO request to the target gNB, the HO request including the UE context. As such, the target gNB has the UE context, including the inter-cell mTRP configurations. In step 310, the target gNB sends a HO request Acknowledgment to the source gNB. In step 315, the source gNB sends a RRC Reconfiguration with a HO command to the UE. Then, in step 320, the UE may declare HO failure (HOF) and then initiates the re-establishment procedure. The UE also performs a cell selection (e.g. selects a cell in the target gNB) in step 325. In step 330, the UE releases one or more inter-cell mTRP configurations. In another example, the UE can release the one or more inter-cell mTRP configurations upon declaring HOF.

In step 335, the UE sends a RRC Re-establishment request to the target gNB. As the network node (target gNB) is aware that the UE has deleted one or more inter-cell mTRP configurations, upon receiving the re-establishment request, the re-establishment node (e.g. target gNB) deletes the one or more inter-cell mTRP configurations from the UE context, before possibly deciding to add new inter-cell mTRP configurations.

In step 340, the target gNB sends a Re-establishment to the UE, in response to the request of step 335.

In step 345, the UE sends a Re-establishment Complete message to the target gNB.

In step 350, the target gNB can determine to add (or not) one or more inter-cell mTRP configurations for the UE.

In step 355, the target gNB sends a RRC Reconfiguration (with the added inter-cell mTRP configurations, if it has been determined so in step 350) to the UE.

In step 360, the UE sends a RRC Reconfiguration Complete to the target gNB.

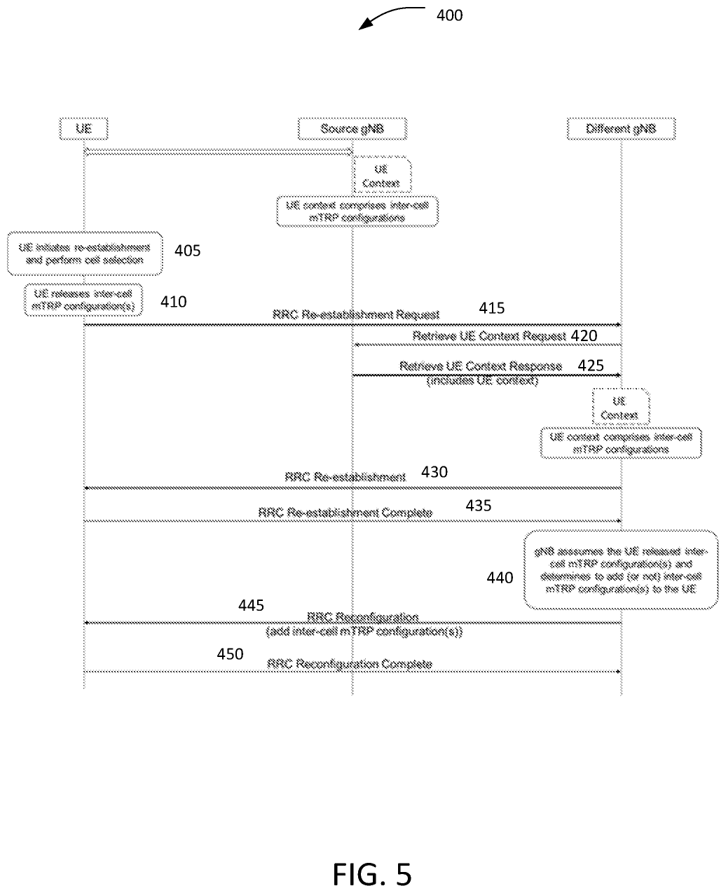

The signaling flowchart 400 of FIG. 5 illustrates a UE releasing at least one inter-cell mTRP configuration and re-establishing in a cell from a gNB which is not prepared but which is the gNB that releases the one or more inter-cell mTRP configuration(s) from the UE context.

For example, the UE is configured to release at least one of the inter-cell mTRP configurations upon initiating the re-establishment procedure. The network node (e.g. a different gNB/target gNB or a source gNB) may have determined to release one or more inter-cell mTRP configurations and indicated such action to the UE. Alternatively, both the network node and the UE have decided to release one or more inter-cell mTRP configurations.

The re-establishment cell is served by a network node (e.g. called different gNB in FIG. 5) that is different from the node associated with the target cell of the HO.

In FIG. 5, first the UE is connected to the source gNB, in which the UE context is stored. The UE context comprises the inter-cell mTRP configurations. The UE first declares HOF and then initiates the re-establishment procedure and performs a cell selection, in step 405.

In step 410, the UE releases one or more of the inter-cell mTRP configuration. However, it is not precluded that the UE releases the one or more inter-cell mTRP configurations immediately upon declaring HOF.

In step 415, the UE sends a RRC Re-establishment Request to the target gNB (called different gNB), which is different from the source gNB.

In step 420, the target gNB sends a UE retrieve Context Request to the source gNB. In response to that request, the source gNB sends the retrieve context response to the target gNB, in step 425. The retrieve UE context response includes the UE context, which comprises the inter-cell mTRP configurations.

As the network node (e.g. source gNB or different gNB) is aware that the UE has deleted one or more inter-cell mTRP configurations, upon receiving a re-establishment request and upon receiving the UE context from the source gNB associated to the source cell of the HO, the re-establishment node deletes the one or more inter-cell mTRP configurations from the UE context, before possibly deciding to add new inter-cell mTRP configurations.

In step 430, the target gNB sends a RRC re-establishment message to the UE.

In step 435, the UE sends a message of RRC Re-establishment Complete to the target gNB, once the UE is connected to the target gNB.

In step 440, the target gNB can determine to add or not one or more inter-cell mTRP configurations to the inter-cell mTRP configurations of the UE.

In step 445, the target gNB sends a RRC reconfiguration message to the UE, the message comprising the added inter-cell mTRP configuration(s), if it was determined in step 440.

In step 450, the UE sends the RRC Reconfiguration complete message to the target gNB, in response to the message in step 445.

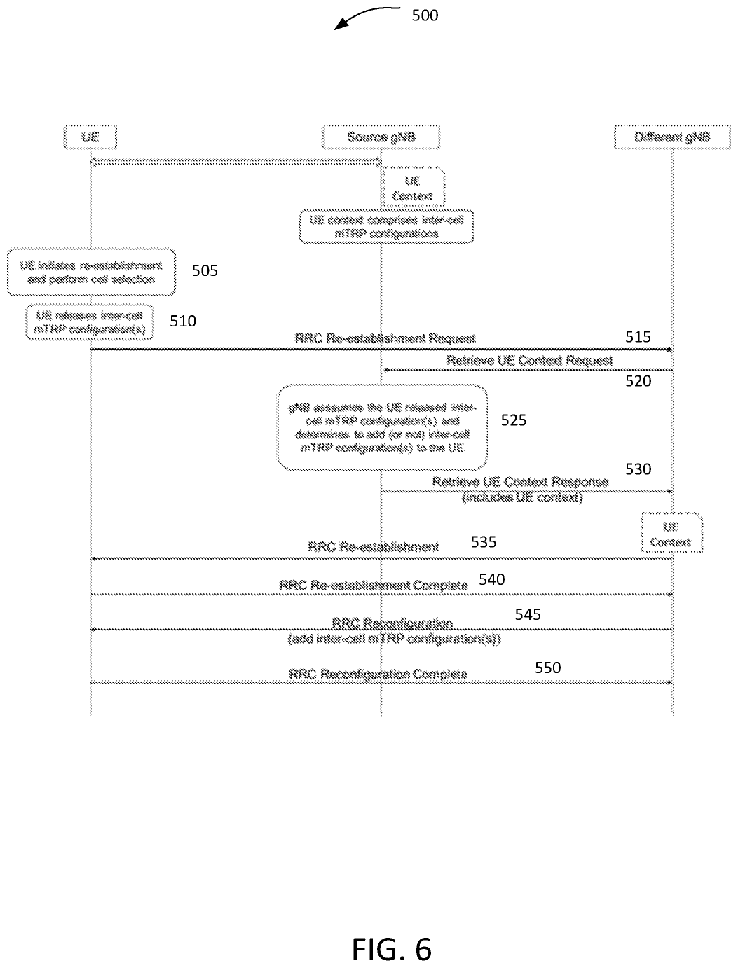

The example signaling flowchart 500 of FIG. 6 illustrates a UE releasing at least one inter-cell mTRP configurations and re-establishing in a cell from a gNB which is not prepared and which is the last serving gNB that releases at least one inter-cell mTRP configuration(s) from the UE context before providing the UE context to the new gNB.

In this case, for example, the UE is configured to release at least one of the inter-cell mTRP configurations upon initiating the re-establishment procedure. The network node (e.g. a different gNB/target gNB or a source gNB) may have determined to release one or more inter-cell mTRP configurations and indicated such action to the UE. Alternatively, both the network node and the UE have decided to release one or more inter-cell mTRP configurations.

The re-establishment cell can be served by a network node (e.g. called different gNB in FIG. 6) that is different from the network node associated with the target cell of the HO.

It should be noted that the signaling 500 flowchart indicates a UE procedure where the UE initially declares HOF and then initiates the re-establishment procedure and then releases the at least one inter-cell mTRP configuration. However, this should be seen as an example, i.e. it is not precluded that the UE releases the inter-cell mTRP configurations immediately upon declaring HOF. As such, the first steps (505 to 520) are similar to steps 405 to 420 of FIG. 5.

As the network node (e.g. source gNB, the different gNB, target gNB) is aware that the UE has deleted one or more inter-cell mTRP configurations, upon receiving a re-establishment request, the re-establishment node (e.g. different gNB) sends a UE context retrieval request to the source node (e.g. source gNB) of the HO. As the source node that served the UE is aware that the UE has deleted one or more inter-cell mTRP configurations, it removes the inter-cell mTRP configurations from the UE context upon receiving a UE context fetch request from the re-establishment node. In this case, the UE context received by the re-establishment node in step 530 is already without the one or more inter-cell mTRP configurations. The re-establishment node stores the received UE context.

Steps 535 to 550 are similar to steps 430, 435, 445 and 450.

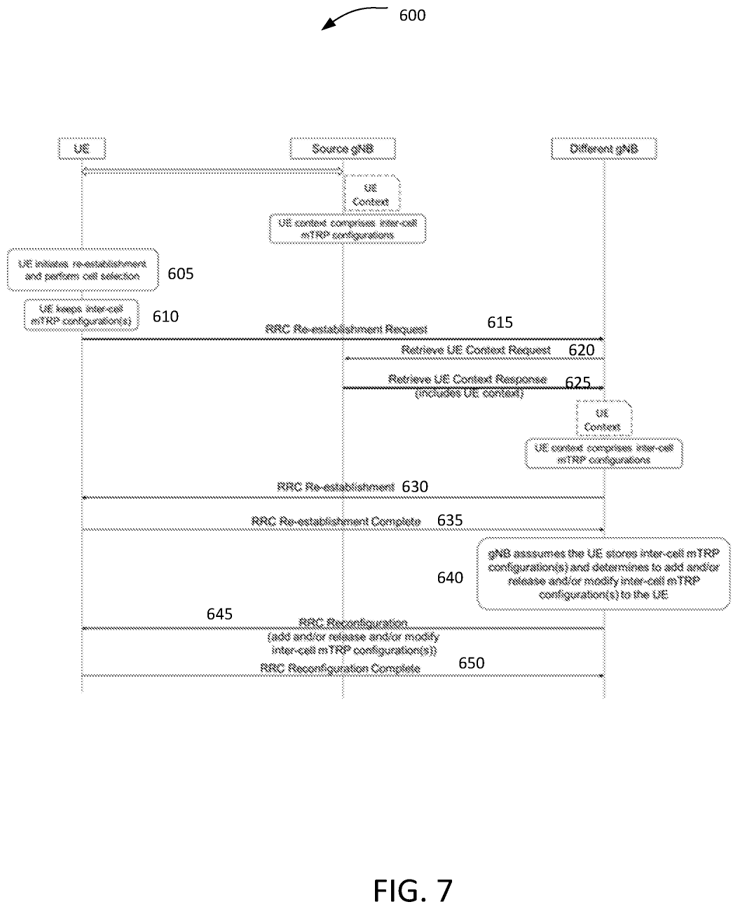

The example signaling flowchart 600 of FIG. 7 illustrates a UE keeping (storing) at least one inter-cell mTRP configuration and re-establishing in a cell from a gNB which is not prepared.

For example, in this case, the UE is configured to keep at least one of the inter-cell mTRP configurations upon initiating the re-establishment procedure. The network node (e.g. a different gNB/target gNB or a source gNB) may have determined to keep one or more inter-cell mTRP configurations and indicated such action to the UE. Alternatively, both the network node and the UE have decided to keep one or more inter-cell mTRP configurations.

As shown in FIG. 7, first the UE is connected to the source gNB, in which the UE context is stored. The UE context comprises the inter-cell mTRP configurations. For some reasons, the connection is suspended and in step 605, the UE initiates the re-establishment procedure towards a cell being served by a target network node (e.g. different gNB) that is different from the source gNB that serves the previous serving cell of the UE. For example, the UE selects a cell served by the target network node.

In step 610, the UE keeps/stores one or more of the inter-cell mTRP configurations.

In step 615, the UE sends a RRC Re-establishment request to the target gNB. In step 620, the target gNB sends a retrieve UE context request to the source gNB. In step 625, the source gNB replies back to the target node, with a Retrieve UE context response, which includes the UE context. Now, the target node has the UE context, which comprises the inter-cell mTRP configurations and it can store it in its memory.

In step 630, the target node sends a RRC Re-establishment message to the UE. In step 635, the UE replies back with a RRC Re-establishment Complete message.

As the re-establishment node (e.g. the different gNB) is aware that the UE has kept one or more inter-cell mTRP configurations, it can send a delta signaling associated to the stored inter-cell mTRP configurations received in the UE context as shared by the source node, i.e., it can add/remove/modify the inter-cell mTRP configurations, in step 640.

In step 645, the target node/re-establishment node sends a RRC Reconfiguration message to the UE, the message comprising the added/removed/modified inter-cell mTRP configurations. In step 650, the UE sends a Reconfiguration Complete message to the target node.

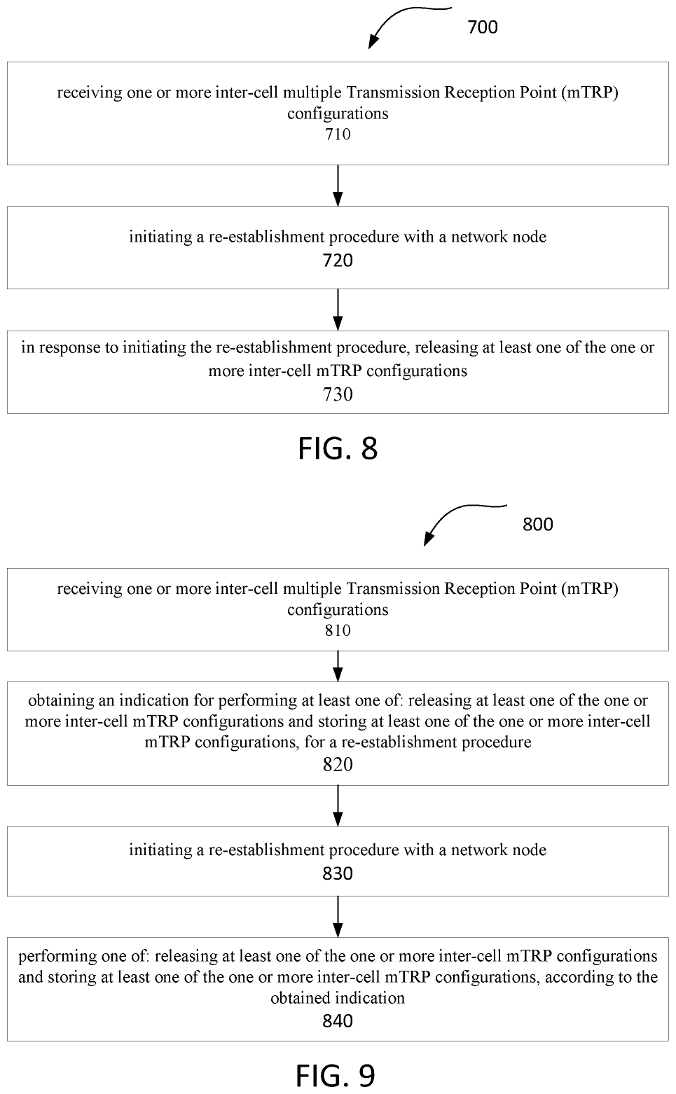

Now turning to FIG. 8, a method 700 in a UE/wireless device for re-establishing a connection, in the context of inter-cell mTRP will be described. Method 700 comprises:
Step 710: receiving one or more inter-cell mTRP configuration(s);
Step 720: initiating a re-establishment procedure with a network node; and
Step 730: in response to initiating the re-establishment procedure, releasing at least one of the one or more inter-cell mTRP configurations.

This method may correspond to a process performed by the UE in any of the cases of FIG. 2 to FIG. 7.

In some examples, the one or more inter-cell mTRP configurations configure the UE with multiple PCIs, for a mobility procedure, wherein the UE is configured with one or more cells operating in a same serving frequency, each cell associated with one or more PCIs. In some examples, upon releasing the at least one or more inter-cell mTRP configurations, the UE may stop operating according to the one or more inter-cell mTRP configurations that have been released. In some examples, the received one or more inter-cell mTRP configurations comprise one of the following: parameters associated with the one or more inter-cell mTRP configurations in which a TRP is defined as an independent cell; parameters associated with the one or more inter-cell mTRP configurations in which a TRP is modelled as a BWP; parameters associated with the one or more inter-cell mTRP configurations in which a TRP is modelled as a dedicated resource; parameters associated with the one or more inter-cell mTRP configurations in which a TRP is defined as a non-serving cell. In some examples, the UE may be configured to release one or more inter-cell mTRP configurations. In some examples, the UE may receive an indication to release the at least one inter-cell mTRP configurations. In some examples, the UE may receive a configuration for one or more additional inter-cell mTRP configurations

FIG. 9 illustrates a method 800 in a UE for re-establishing a connection, in the context of inter-cell mTRP. Method 800 comprises:
Step 810: receiving one or more inter-cell mTRP configurations;
Step 820: obtaining an indication for performing at least one of: releasing at least one of the one or more inter-cell mTRP configurations and storing at least one of the one or more inter-cell mTRP configurations, for a re-establishment procedure;
Step 830: initiating a re-establishment procedure with a network node; and
Step 840: performing one of: releasing at least one of the one or more inter-cell mTRP configurations and storing at least one of the one or more inter-cell mTRP configurations, according to the obtained indication.

In some examples, with the one or more inter-cell mTRP configurations, the wireless device can be configured with multiple PCIs, for a mobility procedure, wherein the wireless device is configured with one or more cells operating in a same serving frequency, each cell associated with one or more PCIs. In some examples, the UE may receive a configuration for one or more additional inter-cell mTRP configurations. For example, the configuration may be a delta configuration. In some examples, the network node is one of a source node, a target node or another network node. In some examples, the one or more inter-cell mTRP configuration(s) may comprise at least one of the following (or any combinations of these):
Parameter(s) (and/or fields and/or IEs such as the ones included in the IE ServingCellconfig or ServingCellconfigCommon (as defined in TS 38.331), for the configuration of a cell and/or PCI to be used for inter-cell mTRP operation; these parameters may be included in a new IE (not necessarily within the IE ServingCellConfig ServingCellconfigCommon), though there may be similar or the same parameters;
Parameter(s) enabling the UE to perform measurements on cells which are configured for inter-cell mTRP such as: i) at least one SS/PBCH block (SSB) measurement timing configuration (SMTC), Channel State information (CSI) measurement configuration, Channel State information (CSI) reporting configuration;
Parameter(s) enabling the UE to perform Layer 1 measurements (such as SS-Reference Signal Received Power (RSRP), SS-Reference Signal Received Quality (RSRQ)) on cells which are configured for inter-cell mTRP;
Parameter(s) enabling the UE to perform inter-cell mTRP operation(s), such as adding or activating a cell/PCI for transmissions and/or removing or deactivating a cell/PCI for transmissions and/or receptions on a channel (e.g. PDCCH, PDSCH, PUSCH, PUCCH, PBCH),
TCI state configuration(s) having as QCL configuration a RS of a cell which is not the source cell the UE was connected before initiating the re-establishment procedure, e.g. the cell where a Radio Link failure (RLF) was detected.
Beam indications for beams of a cell which is not the source cell the UE was connected before initiating the re-establishment procedure, e.g. the cell where a RLF was detected.
Configuration(s) of DL channels, such as, PDSCH, Control Resource Set (CORESET) for the cell configured for inter-cell mTRP operation, where the DL channels are UE-dedicated configuration and/or cell-specific/common configuration(s);
Configuration(s) of UL channels, such as PUCCH, PUSCH, for the cell configured for inter-cell mTRP operation, wherein the DL channels are UE-dedicated configuration and/or cell-specific/common configuration(s);
C-RNTI or the set of C-RNTIs such as the ones included in the SpCellConfig for the UE to use in the respective PCIs as configured in the inter-cell mTRP operation;
Parameter(s) associated to 3GPP Option 1, in which a TRP with different PCI(s) is defined as an independent cell;
   a. See Option 1's first 4 characteristics as described above.
   b. When the Assisting Cell is used for UL, RLM should follow the Assisting Cell signals (whether this is part of Main cell (legacy serving cell) or as separate Assisting Cell RLM can be determined).
   c. In a sub-option, each inter-cell mTRP configuration has its own ServingCellConfig (so the UE is configured with multiple ServingCellConfig(s), one per TRP) and its own ServingCellConfigCommon (so the UE is configured with multiple ServingCellConfig(s), one per TRP);
   d. In a sub-option, each inter-cell mTRP configuration has its own ServingCellConfig (so the UE is configured with multiple ServingCellConfig(s), one per TRP), but there is a single ServingCellConfigCommon, possibly associated to the initial PCell (the PCell the UE initially connects to and/or performs reconfiguration with sync).
Parameter(s) associated to 3GPP Option 2, in which a TRP with different PCI(s) is modelled as additional BWP:
   a. see the characteristics of Option 2 as described above.
Parameter(s) associated to 3GPP Option 3, in which the TRP with different PCI(s) is modelled as beam resource(s) (e.g. TCI state, QCL-info), such as one of the following or combinations of the following:
   a. The TRP with different PCI(s) is modelled as a dedicated resource to enable separate beam, i.e. separate TCI-state/QCL-info.
   b. See the characteristics of Option 3 as described above.
Parameter(s) associated to 3GPP Option 4, in which a new structure is defined. For example, a new IE (e.g. NonServingCellConfig) is defined to include all non-serving cell information (i.e. TRP with different PCI):
   See the characteristics of Option 4 as described above.

Upon releasing the one or more inter-cell mTRP configuration(s), the UE may stop operating according to the inter-cell mTRP configuration(s), such as stopping performing measurements according to the L1 measurement configuration and based on the one or more inter-cell mTRP configuration(s), stopping transmissions/receptions on the cells configured for inter-cell mTRP, stopping monitoring physical channels (e.g. PDCCH, PDSCH, PBCH) with the cells configured for inter-cell mTRP, stopping transmissions on UL physical channels (e.g. PUCCH, PUSCH, PRACH) with the cells configured for inter-cell mTRP, resetting the MAC entity, resetting counters and/or timers associated to inter-cell mTRP configuration(s), suspending the inter-cell mTRP configurations, etc.

In some examples, releasing at least one of the one or more inter-cell mTRP configuration(s) or storing at least one of the one or more inter-cell mTRP configuration(s) may be based on an indication received from the network node. In some examples, an inter-cell mTRP configuration can be configured/re-configured in an add/mod- and release-lists, to benefit from delta signaling (stored information remains and can be modified or released, while new configurations may be added, e.g. new inter-cell mTRP configuration(s)) either i) when the UE releases at least one inter-cell mTRP configuration(s) but may be re-configured (added and/or modified) in the first RRC Reconfiguration message after the re-establishment procedure; or ii) when the UE stores at least one inter-cell mTRP configuration(s) but may be re-configured (added and/or modified) in the first RRC Reconfiguration message after re-establishment.

In some examples, the event which triggers the initiation of a re-establishment procedure may be at least one of the following:
Detecting RLF of the MCG;
Timer t316 is not configured;
SCG transmission is suspended;
detecting RLF of the MCG while PSCell change or PSCell addition is ongoing;
re-configuration with sync failure of the MCG (e.g. timer T304 expires);
mobility from NR failure;
integrity check failure indication from lower layers concerning SRB1 or SRB2;
upon an RRC connection reconfiguration failure;
upon detecting RLF for the SCG while MCG transmission is suspended;
upon reconfiguration with sync failure of the SCG while MCG transmission is suspended;
upon SCG change failure while MCG transmission is suspended;
upon SCG configuration failure while MCG transmission is suspended;
upon integrity check failure indication from SCG lower layers concerning SRB3 while MCG is suspended;
upon T316 expiry;
upon detecting a failure associated to inter-cell mTRP operation;

In some examples, the initiation of a re-establishment procedure may comprise at least one of the following:
Starting a timer T311;
Performing a cell selection;
Transmitting an RRC Reestablishment Request message to the selected cell.

In some examples, receiving one or more inter-cell mTRP configuration(s) may comprise receiving the one or more inter-cell mTRP configuration(s), while the UE is connected mode (e.g. RRC_CONNECTED), or while the UE transitions to connected state from idle state (RRC_IDLE) or inactive state (RRC_INACTIVE), or during a HO (as a target cell configuration).

In some examples, the one or more inter-cell mTRP configuration(s) may be received in an RRC Reconfiguration (RRCReconfiguration) message, or in an RRC Resume message (e.g. RRCResume).

In some examples, obtaining an indication may comprise receiving a message from the network node. Another indication can be obtained via the configuration of the UE, e.g. the UE being configured with one of releasing at least one of the one or more inter-cell mTRP configurations and storing at least one of the one or more inter-cell mTRP configurations.

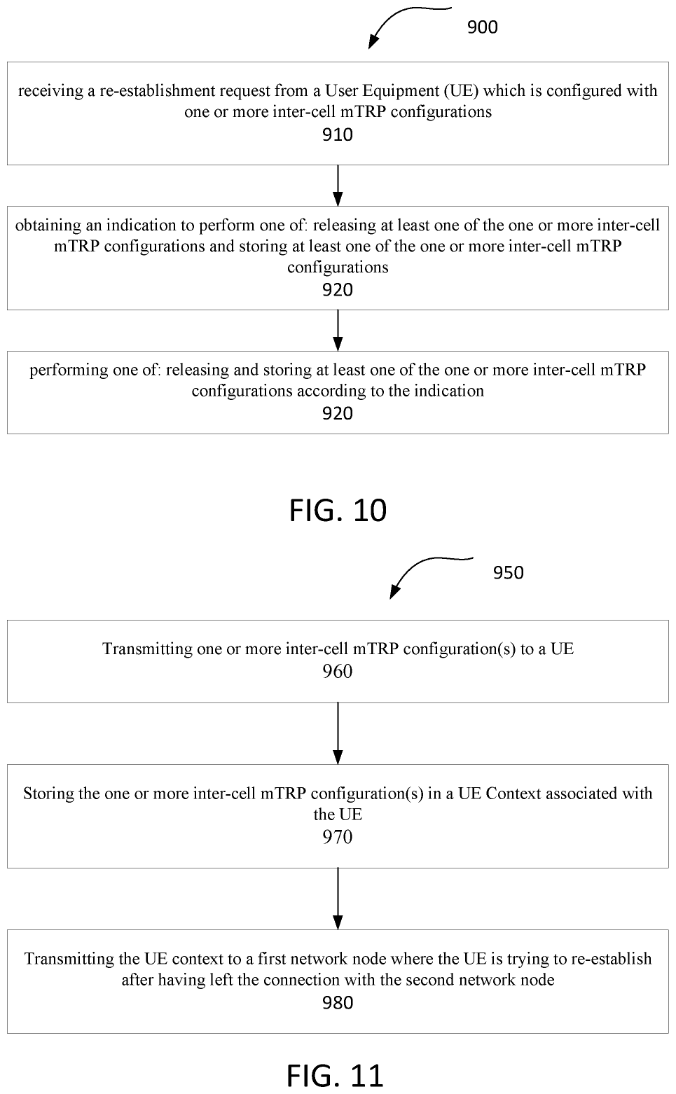

FIG. 10 illustrates a method 900 in a network node, e.g. a target gNB, communicating with a UE performing a re-establishment procedure. Method 900 comprises:
Step 910: receiving a re-establishment request from a UE which is configured with one or more inter-cell mTRP configurations;
Step 920: obtaining an indication to perform one of: releasing at least one of the one or more inter-cell mTRP configurations and storing at least one of the one or more inter-cell mTRP configurations; and
Step 930: performing one of: releasing and storing at least one of the one or more inter-cell mTRP configurations according to the indication.

This method may correspond to a method implemented in the last serving gNB of FIGS. 2 and 3, in the target node of FIG. 4, in the different gNB of FIGS. 5 to 7.

In some examples, the one or more inter-cell mTRP configurations configure the UE with multiple PCIs, for a mobility procedure, wherein the UE is configured with one or more cells operating in a same serving frequency, each cell associated with one or more PCIs. In some examples, upon releasing the at least one or more inter-cell mTRP configurations, the network node may stop operating according to the one or more inter-cell mTRP configurations that have been released. In some examples, the one or more inter-cell mTRP configurations may comprise the same parameters as described above (with regards to method 700). In some examples, the network node may send a configuration for one or more additional inter-cell mTRP configurations to the UE. In some examples, further comprising obtaining a UE context from a previous network node to which the UE was connected. In some examples, the UE context may comprise an indication that the UE (trying to re-establish the connection) has released the at least one inter-cell mTRP configuration or stored at least one of the one or more inter-cell mTRP configurations.

In some examples, the obtained UE context may comprise the one or more inter-cell mTRP configurations of the UE. In some examples, the network node may determine whether the obtained UE Context contains at least one of the one or more inter-cell mTRP configurations.

In some examples the network node may further determine one or more of: adding one or more inter-cell mTRP configurations; releasing one or more inter-cell mTRP configurations; and modifying one or more inter-cell mTRP configurations.

In some examples, the request for re-establishing a connection can be a Re-establishment Request message. The Re-establishment Request message can be an RRCReestablishmentRequest message as defined in TS 38.331 or it can be any message the UE transmits to indicate to the network that it is trying to re-establish the connection, e.g. transmitted after a failure has been detected.

In some examples, obtaining the UE context may comprise any action for getting access to the UE context, such as retrieving it from memory or from another network node and/or from a database (internal or external to the first network node).

In some examples, obtaining the UE context may be done via a UE context fetching procedure as defined in TS 38.324. In some examples, the network node may send an RRC Reestablishment message to the UE. In some examples, the network node may receive an RRC Reestablishment Complete message. In some examples, the network node may transmit a RRC Reconfiguration message to the UE after the re-establishment procedure based on the UE context.

In some examples, the release of the one or more inter-cell mTRP configuration(s) based on the indication may be associated to a UE capability. In one option, the UE is not capable of storing the inter-cell mTRP configuration(s), so that the indication may be an absence of UE capability (e.g. UE capability not being present). For example, if the UE capability for storing inter-cell mTRP configuration(s) upon re-establishment is absent, the network node interprets that the UE has released the inter-cell mTRP configuration(s) and thus it also releases the inter-cell mTRP configuration(s). The UE capability for storing inter-cell mTRP configuration(s) can be transmitted by a network node as part of the UE Radio Capability signaling message, e.g. in an RRC message and IE.

In some examples, the storing of inter-cell mTRP configuration(s) based on the indication may be associated to a UE capability. In one option, the UE is capable of storing the inter-cell mTRP configuration(s), so that the indication may be that the UE capability is present. For example, if the UE capability for storing inter-cell mTRP configuration(s) upon re-establishment is present, the first network node interprets that the UE has stored the inter-cell mTRP configuration(s), thus it also stores the inter-cell mTRP configuration(s). The UE capability for storing inter-cell mTRP configuration(s) can be transmitted by a network node of the network as part of the UE Radio Capability signaling message, e.g. in an RRC message and IE.

In some examples, determining whether the obtained UE Context (of the UE which has transmitted the Re-establishment Request message) may contain at least one of the one or more inter-cell mTRP configuration(s) may comprise determining that the UE Context does not contain one or more inter-cell mTRP configuration(s), because the one or more inter-cell mTRP configuration(s) have been released by the last serving gNB.

In some examples, the RRC Reconfiguration message transmitted to the UE may comprise at least one of the following:
one or more inter-cell mTRP configuration(s) being added;
one or more inter-cell mTRP configuration(s) being released;
one or more inter-cell mTRP configuration(s) being modified;
one or more inter-cell mTRP configuration(s) being activated;
one or more inter-cell mTRP configuration(s) being deactivated;

In some examples, the first network node where the UE is trying to re-establish (i.e. which received the Re-establishment Request message) is one of the following:
the last serving network node which the UE was connected to when the re-establishment procedure was triggered, in the case the UE re-establishes in the last serving gNB (e.g. that's the case illustrated in FIGS. 2 and 3);
a network node different from the last serving gNB, in the case the UE re-establishes in a different node. In one example, the different network node/first network node is a prepared network node, i.e. the first network node where the UE is trying to re-establish has received the UE context from a second network node (operating as a source network node in a mobility/HO procedure) in a HO Request message for example. The HO Request message may include the UE identity associated with the UE context (that's the case illustrated in FIG. 4; or
a network node different from the last serving gNB, in the case the UE re-establishes in a different node. In another example, the different network node/first network node is not a prepared network node, as such the first network node needs to retrieve the UE context by requesting it from the last serving network node where the UE context is located. In this case, retrieving the UE context may comprise obtaining the UE context by requesting it to the last serving network node where the UE context is located. This is the case illustrated in FIGS. 5 to 7.

As a note, the one or more inter-cell mTRP configurations are similar to those discussed when describing methods 700 and 800.

FIG. 11 illustrates a method 950 performed by a first network node serving the UE and having a UE context. The method may comprise:
Step 960: Transmitting one or more inter-cell mTRP configuration(s) to a UE;
Step 970: Storing the one or more inter-cell mTRP configuration(s) in a UE Context associated with the UE; and
Step 980: Transmitting the UE context to a second network node where the UE is trying to re-establish after having left the connection with the first network node.

This method may correspond to method implemented in the last serving gNB of FIGS. 2 and 3, or in the source gNB of FIGS. 4 to 7.

In some examples, transmitting the UE context to a second network node may comprise transmitting a HO Request message, wherein the HO Request message comprises the UE context. In some examples, transmitting the UE context to a second network node may comprise responding to a UE context retrieve request message from the second network node.

In some examples, before transmitting the UE context, the first network node may perform one of: releasing at least one of the one or more inter-cell mTRP configuration(s) from the UE Context associated with the UE (which has transmitted the Re-establishment Request message); and storing at least one of the one or more inter-cell mTRP configuration(s) from the UE Context associated with the UE (which has transmitted the Re-establishment Request message).

In some examples, the first network node may stop performing inter-cell mTRP operations, such as stopping performing measurements based on inter-cell mTRP configuration(s), stopping transmissions/receptions on the cells configured for inter-cell mTRP, stopping monitoring physical channels (e.g. PDCCH, PDSCH, PBCH) with the cells configured for inter-cell mTRP, stopping transmissions on UL physical channels (e.g. PUCCH, PUSCH, PRACH) with the cells configured for inter-cell mTRP.

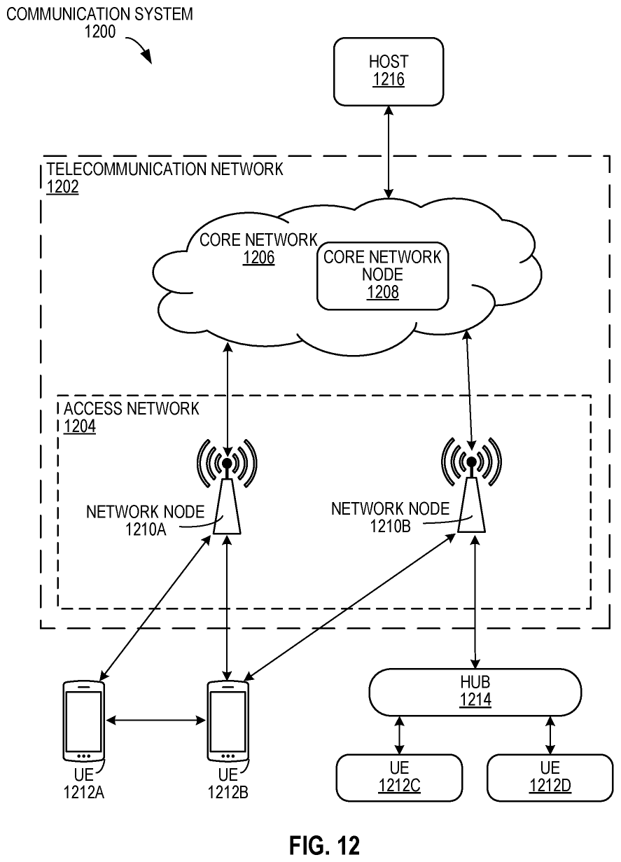

FIG. 12 shows an example of a communication system 1200 in accordance with some embodiments.

In the example, the communication system 1200 includes a telecommunication network 1202 that includes an access network 1204, such as a RAN, and a core network 1206, which includes one or more core network nodes 1208. The access network 1204 includes one or more access network nodes, such as network nodes 1210a and 1210b (one or more of which may be generally referred to as network nodes 1210), or any other similar 3GPP access node or non-3GPP access point. The network nodes 1210 facilitate direct or indirect connection of UE, such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202 and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); LTE, and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

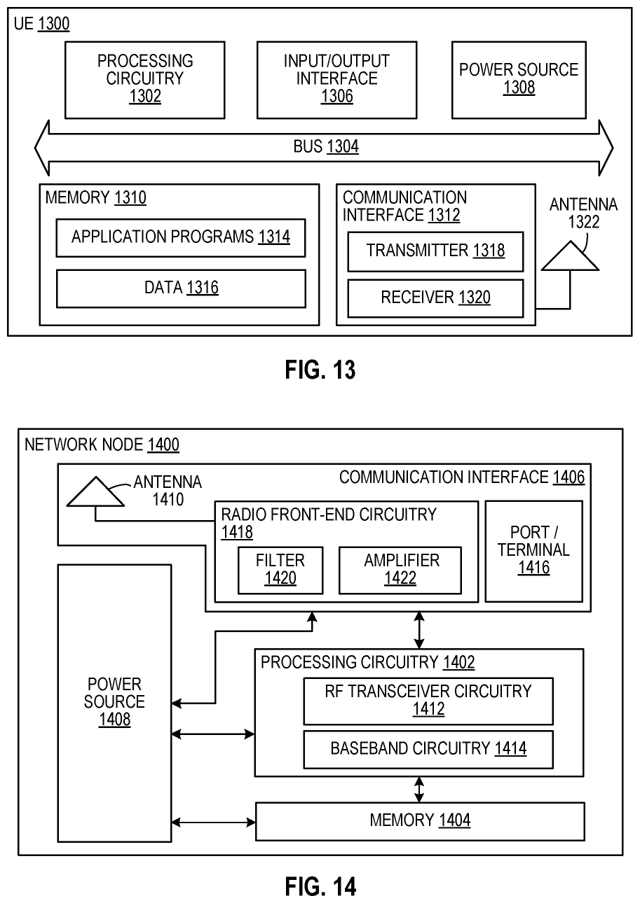

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.” The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately. Furthermore, the processing circuitry 1302 is configured to perform any of the steps of methods 700 and 800 of FIGS. 8 and 9 respectively.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units. Furthermore, the processing circuitry 1402 is configured to perform any of the steps of methods 900 and 950 of FIGS. 10 and 11 respectively.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

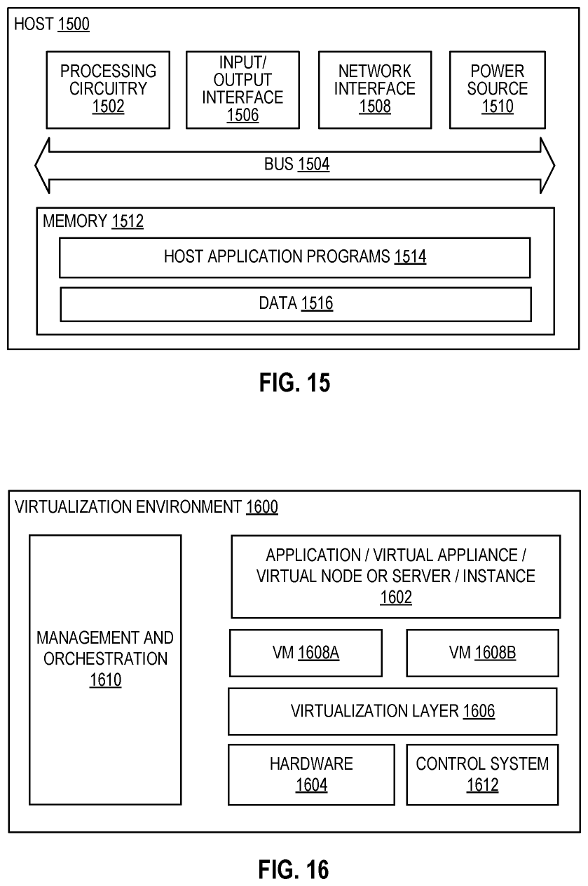

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

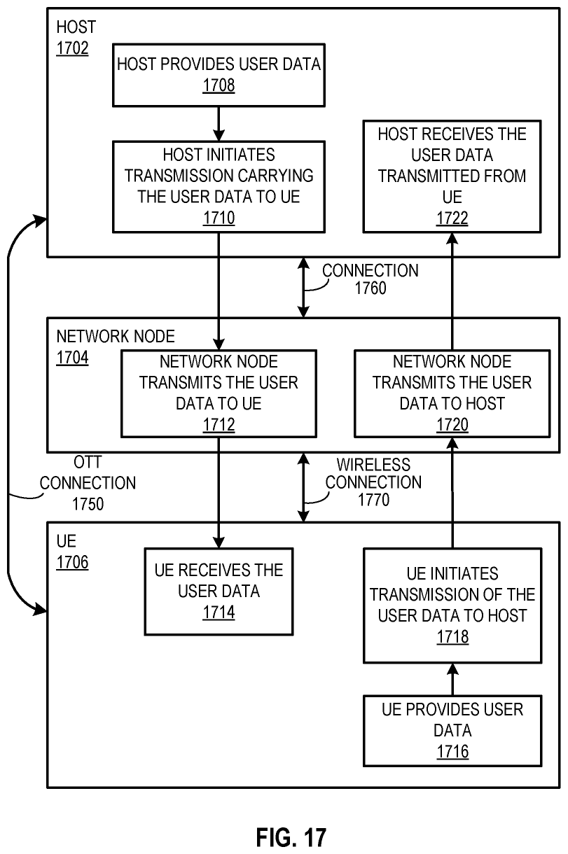

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve the data rate, latency, power consumption and thereby provide benefits such as reduced user waiting time, better responsiveness, extended battery lifetime.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-7. (canceled)

8. A method performed by a user equipment (UE), the method comprising:
receiving one or more inter-cell multiple Transmission Reception Point (mTRP) configurations;
obtaining an indication for performing at least one of: releasing at least one of the one or more inter-cell mTRP configurations and storing at least one of the one or more inter-cell mTRP configurations, for a re-establishment procedure;
initiating a re-establishment procedure with a network node; and
performing one of: releasing at least one of the one or more inter-cell mTRP configurations and storing at least one of the one or more inter-cell mTRP configurations, according to the obtained indication.

9. The method of claim 8, wherein the one or more inter-cell mTRP configurations configure the UE with multiple Physical Cell Identities (PCIs), for a mobility procedure, wherein the UE is configured with one or more cells operating in a same serving frequency, each cell associated with one or more PCIs.

10. The method of claim 8, further comprising, upon releasing the one or more inter-cell mTRP configurations, stopping operating according to the one or more inter-cell mTRP configurations that have been released.

11. The method of claim 8, further comprising receiving a configuration for one or more additional inter-cell mTRP configurations.

12. The method of claim 11, wherein the configuration is a delta configuration.

13. (canceled)

14. The method of claim 8, wherein the received one or more inter-cell mTRP configurations comprise one of the following: parameters associated with the one or more inter-cell mTRP configurations in which a TRP is defined as an independent cell; parameters associated with the one or more inter-cell mTRP configurations in which a TRP is modelled as a bandwidth part (BWP); parameters associated with the one or more inter-cell mTRP configurations in which a TRP is modelled as a dedicated resource; parameters associated with the one or more inter-cell mTRP configurations in which a TRP is defined as a non-serving cell.

15. The method of claim 8, wherein obtaining an indication comprises receiving a message from the network node or the UE being configured with one of releasing at least one of the one or more inter-cell mTRP configurations and storing at least one of the one or more inter-cell mTRP configurations.

16. (canceled)

17. A method in a network node, the method comprising:
receiving a re-establishment request from a User Equipment (UE) which is configured with one or more inter-cell mTRP configurations;
obtaining an indication to perform one of: releasing at least one of the one or more inter-cell mTRP configurations and storing at least one of the one or more inter-cell mTRP configurations; and
performing one of: releasing and storing at least one of the one or more inter-cell mTRP configurations according to the indication.

18. The method of claim 17, wherein the one or more inter-cell mTRP configurations configure the UE with multiple Physical Cell Identities (PCIs), for a mobility procedure, wherein the UE is configured with one or more cells operating in a same serving frequency, each cell associated with one or more PCIs.

19. The method of claim 17, further comprising, upon releasing the at least one or more inter-cell mTRP configurations, stopping operating according to the one or more inter-cell mTRP configurations that have been released.

20. The method of claim 17, wherein the one or more inter-cell mTRP configurations comprise one of the following: parameters associated with the one or more inter-cell mTRP configurations in which a TRP is defined as an independent cell; parameters associated with the one or more inter-cell mTRP configurations in which a TRP is modelled as a BWP; parameters associated with the one or more inter-cell mTRP configurations in which a TRP is modelled as a dedicated resource; parameters associated with the one or more inter-cell mTRP configurations in which a TRP is defined as a non-serving cell.

21. The method of claim 17, further comprising sending a configuration for one or more additional inter-cell mTRP configurations to the UE.

22. The method of claim 17, further comprising obtaining a UE context from a previous network node to which the UE was connected.

23. The method of claim 22, wherein the UE context comprises an indication that the UE has released the at least one inter-cell mTRP configuration or stored at least one of the one or more inter-cell mTRP configurations.

24. The method of claim 22, wherein the obtained UE context comprises the one or more inter-cell mTRP configurations of the UE.

25. The method of claim 17, wherein releasing the one or more inter-cell mTRP configurations is associated with a UE capability or wherein storing the one or more of the inter-cell mTRP configurations is associated with a UE capability.

26. (canceled)

27. (canceled)

28. The method of claim 27, wherein determining whether the obtained UE Context contains at least one of the one or more inter-cell mTRP configurations comprises determining that the UE Context does not contain one or more inter-cell mTRP configurations, which have been released by a second network node.

29. (canceled)

30. The method of claim 29, further comprising sending a message to the UE, the message comprising at least one of the following:
the one or more inter-cell mTRP configurations determined to be added;
the one or more inter-cell mTRP configurations determined to be released;
the one or more inter-cell mTRP configurations determined to be modified;
the one or more inter-cell mTRP configurations being activated;
the one or more inter-cell mTRP configurations being deactivated.

31. The method of claim 17, wherein the network node is one of the following:
the same network node as a last serving network node;
a network node different from the last serving network node, but prepared for the re-establishment procedure;
a network node different from the last serving network node, but not prepared for the re-establishment procedure.

32. A User Equipment (UE) comprising network interfaces and processing circuitry connected thereto and configured to:
receive one or more inter-cell multiple Transmission Reception Point (mTRP) configurations;
obtain an indication for performing at least one of: releasing at least one of the one or more inter-cell mTRP configurations and storing at least one of the one or more inter-cell mTRP configurations, for a re-establishment procedure;
initiate a re-establishment procedure with a network node; and
perform one of: releasing at least one of the one or more inter-cell mTRP configurations and storing at least one of the one or more inter-cell mTRP configurations, according to the obtained indication.

33. (canceled)

34. (canceled)
